(19) United States
(12) Patent Application Publication
(10) Pub. No.: US 2013/0284730 A1
(43) Pub. Date: Oct. 31, 2013

(54) Container for Transporting A Vehicle

(71) Applicant: Sven Kohlgrüber, Morfelden-Waldorf (DE)

(72) Inventor: Sven Kohlgrüber, Morfelden-Waldorf (DE)

(73) Assignee: Deutsche Post AG, Bonn (DE)

(21) Appl. No.: 13/879,124

(22) PCT Filed: Oct. 13, 2011
(86) PCT No.: PCT/EP2011/067851

§ 371 Date: Jun. 21, 2013

(30) Foreign Application Priority Data
Oct. 15, 2010 (DE) 10 2010 042 510.9

(51) Int. Cl. B60P 3/075

(52) U.S. Cl. CPC B60P 3/075
USPC 220/1.5; 410/3

(57) ABSTRACT

The subject innovation relates to a container for transporting a vehicle, the container being of substantially cuboid construction with a first and a second end face, two longitudinal sides, a bottom and a top. The problem addressed by the subject innovation is that of producing a container for transporting vehicles which is suitable for transport by air or sea freight and by land, and which requires a minimized amount of space when transported empty. The vehicle should be protected from the sight of unauthorized persons and not have to be unloaded from the container even when transported in a mixed manner by land, sea and/or air. To that end, according to the subject innovation, a container is proposed, the bottom having a base element opposite which a cowl containing the second end face, the two longitudinal sides and the top can be displaced.

### CROSS-REFERENCE TO RELATED APPLICATIONS

Pursuant to 35 U.S.C. §371, this application is the United States National Stage Application of International Patent Application No. PCT/EP2011/067851, filed on Oct. 13, 2011, the contents of which are incorporated by reference as if set forth in their entirety herein, which claims priority to German (DE) Patent Application No. 10 2010 042 510.9, filed Oct. 15, 2010, the contents of which are incorporated by reference as if set forth in their entirety herein.

### BACKGROUND

Vehicles, particularly motor vehicles, are transported in large numbers, at times over long distances. In this process, the vehicles have to be protected against damage. This is especially the case when the vehicles are extremely valuable, in other words, for instance, race cars, old-timers, prototypes, exhibition vehicles or other rare automobiles. Moreover, particularly prototypes have to be shielded from the view of unauthorized persons. For this reason, vehicles are increasingly often being transported in containers.

Containers of the above-mentioned type are known and standardized, for example, in ISO 668. These are so-called sea freight containers, available as 10-foot, 16-foot, 20-foot and 40-foot containers, which are suitable and used, for instance, for the transportation of motor vehicles. Such containers have a very sturdy construction which, however, translates into a high intrinsic weight. For this reason, such containers are not suitable for airfreight transportation. The significance of airfreight of special vehicles, as listed above by way of example, has increased greatly in recent times. If a vehicle is going to be transported by air, it first has to be taken, for instance, in a container of the type described above, to an airport, where it is loaded into a suitable airplane. For this purpose, the vehicle has to be unloaded from the container and placed onto an airplane pallet. This not only entails additional loading work, but also once again entails the risk of damage. In the case of vehicles that have to be shielded from the view of unauthorized persons, additional work is involved in this reloading process. Another drawback of such above-mentioned containers for transporting vehicles lies in the fact that they have a limited inner width that is only slightly greater than the width of many vehicles. This can easily give rise to damage to the vehicles when they are driven into the container. By the same token, the car doors can be easily damaged since, as a rule, they cannot be opened all the way inside the container due to its limited inner width and so they can strike against the inner walls of the container when they are opened. Furthermore, getting into and out of the car is awkward for the personnel loading the vehicles since the doors can only be opened to a limited extent. The vehicles have to be secured in the containers against shifting. This is normally done by securing the wheels of the vehicle. In view of the small inner width of the containers, this, in turn, is very difficult, especially at the end of the vehicle that has been loaded at the side facing away from the loading opening.

European patent application EP 0 319 974 A1 discloses a multi-purpose container that is especially well-suited for transporting motor vehicles. In addition to the normal loading opening in one end face, this container also has closable side walls in the form of doors. Once a vehicle has been driven into the container in such a way that the position of the vehicle door is flush with one side door of the container, the vehicle door can be opened easily and completely when the corresponding side door of the container has been opened. It is now also simple to secure the vehicle that has been driven into the container. For stability reasons, however, it is not possible to design the side wall of the container so that it can be opened over the entire length of the container. Rather, supports have to be permanently installed in the wall of the container between individual openings. Depending on the vehicle that is to be loaded, the vehicle doors can still strike against these supports when they are opened. In any case, at the very least, a frame is provided on the loading opening at the end face of the container, so that the drawback of the risk of damage when the vehicle is being driven into the container is still present. Moreover, this container has the disadvantage that, due to its weight and dimensions, it is not suitable for airfreight.

European patent application EP 1 707 505 A1 discloses a container for transporting a vehicle, said container being essentially cuboidal and having a first end face and a second end face, two lengthwise sides, a bottom and a top, whereby the container has a first end face, a floor element that makes up the bottom, and a superstructure that can move relative to the floor element and that comprises at least the second end face, the two lengthwise sides, and the top.

The volume of this container is fixed and cannot be changed, especially it cannot be lengthened, for example, in order to be able to transport vehicles with an extra long axial chassis.

British patent application GB 2 246 337 A discloses an expansion module for a freight container. Standard freight containers have leaf doors at one end face that are affixed so as to pivot on a hinge situated on each side wall of the container. This patent application proposes expansion modules that can be affixed to these hinges. Here, in one embodiment, two expansion modules can be provided that, instead of each of the leaf doors, are each pivotably affixed to a side wall of the container, and they can close the container analogously to the doors or else they can each be pivoted to one side for opening the container. In another embodiment, it is proposed to provide a cuboidal expansion module that can be attached to the door hinges of the container. The original leaf doors can remain on the container, for example, in that they are affixed in the maximum opened position. On one end face, the expansion module has two leaf doors facing the opening itself. This container can be lengthened, but due to its heavy construction and shape, it is not suitable for air freight.

### SUMMARY

The subject innovation relates to a container for transporting a vehicle, said container being essentially cuboidal and having a first end face and a second end face, two lengthwise sides, a bottom and a top.

Therefore, the objective of the subject innovation is to put forward a container for transporting vehicles that is suitable for transportation by air, by sea as well as by land and that minimizes the risk of damage for the vehicles that are to be transported, especially during loading and unloading. In this context, it should not be necessary to unload the vehicles from the container, even in the case of combined land, sea and/or air transportation. Moreover, the container should also offer the possibility of shielding the vehicle from the view of unauthorized persons.

In one embodiment, a container is structured to be essentially cuboidal and having a first end face and a second end face, two lengthwise sides, a bottom and a top, whereby the container has a first end face, a floor element that makes up the bottom, and a superstructure that comprises the second end face, the two lengthwise sides, and the top. In one embodiment, the superstructure is arranged so as to move relative to the floor element. The loading personnel can move the superstructure in the direction of the side opposite from the loading side in such a way that the floor element is not covered by the superstructure, at least for the most part. Now a vehicle can be driven onto the floor element without the risk that it will hit a side part of the container, thereby damaging the vehicle. The loading personnel can open the car door all the way in order to get out, without the car door coming into contact with the inner wall of the container. Furthermore, it is also possible to open all of the car doors and even, for example, the hood and the trunk lid of the vehicle. Regardless of whether the car has the steering wheel on the right or on the left, it can always be loaded in the same direction, that is to say, forwards. There is sufficient space for the loading personnel to secure the vehicle to the floor element. Once the vehicle has been secured to the floor element, the superstructure can once again be slid back over the floor element. After the first end face—as the loading side—has been closed, the container is closed. This container, together with the vehicle, can now be transported by plane, truck, train or ship, or can be placed into a conventional sea freight container for sea or land transport.

In one embodiment, the second end face of the container has a support element so that, when the first end face of the container is lifted, for example, by an industrial floor truck such as a forklift, it can be moved and slid, for instance, into a sea freight container.

The container can be completely closed. On the first end face, the loading side, there is an opening that can be closed with a reclosable closure element. This closure element can be in the form of a hatch or of a leaf door having one or more leaves. Other suitable closure elements such as accordion doors or roller shutters are conceivable.

In an embodiment, the first end face—as the loading side—consists of a wall that is configured as a drive-on ramp. This ramp has a first end that is pivotably connected to the floor element, and a second upper end. In order to load the container, this ramp is pivoted outward around the pivotable connection to the floor element until its upper end touches the ground. A vehicle can now be placed into the container via this ramp. After the container has been loaded and the vehicle has been secured in the container, the ramp can be placed into an essentially vertical position by being pivoted essentially by 90° around the pivotable connection to the floor element opposite from the first pivoting motion in order to close the first end face of the container. Advantageously, the ramp can be secured to the side walls of the container and/or to the top and/or to the floor element. For weight-saving reasons, the ramp can be made of an aluminum alloy. Of course, other suitable materials such as, for example, steel, are likewise conceivable. Here, the ramp itself can constitute the closure element. However, the container can also be configured in such a way that the ramp is folded into a position that is essentially perpendicular to the floor element and the container can be closed by an additional closure element.

In an embodiment, the container can accommodate additional ramps in the roof structure that, as ramp extensions, make it possible to load vehicles that have a particularly low chassis clearance.

When particularly fragile vehicles are being transported, the walls and the closure element of the container can be insulated in order to reduce the climate fluctuations that might occur inside the container as would be the case with a non-insulated variant. Fluctuations in the temperature and humidity can lead, for example, to the formation of condensation on the vehicle that is being transported, and this is undesired and has to be avoided for certain types of vehicles.

In one embodiment, there is a cable winch inside the container with which the vehicles can be pulled onto and/or into the container without the vehicle having to move under its own engine power. In one embodiment, this cable winch is attached to the floor element. If the cable winch is operated manually, the container can be used for all purposes, and loading with a cable winch such that there is no need for an external source of power.

In another embodiment, the container consists of profiles and metal sheets made of an aluminum alloy. This material offers the advantage that it is lightweight and yet sturdy. However, other lightweight and sturdy materials are likewise conceivable such as, for instance, plastics or composite materials, especially for the superstructure, whereby particularly the floor element can also be made of steel. It has proven to be advantageous to protect the floor element against corrosion. This can be achieved not only by selecting rustproof materials but also by applying suitable treatments that provide corrosion protection such as, for instance, coating or galvanizing.

Other advantages, special features and practical configurations of the subject innovation ensue from the subordinate claims and from the presentation below of the embodiments on the basis of the figures.

### BRIEF DESCRIPTION OF THE DRAWINGS

FIG. 1 illustrates a container with straight walls, a closed superstructure and a leaf door as the closure element, in a perspective view;

FIG. 2 illustrates the container with angled walls, a closed superstructure and a hatch as the closure element, in a perspective view;

FIG. 3 illustrates the container with angled walls, an opened and partially retracted superstructure, in a perspective view;

FIG. 4 illustrates the container with angled and extended walls, a closed superstructure and a hatch as the closure element, in a perspective view;

FIG. 5 illustrates the container with angled walls, a closed superstructure and a leaf door as the closure element, in a perspective view;

FIG. 6 illustrates the view of the second end face of the container with straight walls;

FIG. 7 illustrates detail X from FIG. 6, in an enlarged view;

FIG. 8 illustrates section A-A from FIG. 2;

FIG. 9 illustrates detail L from FIG. 1, in an enlarged view; and

FIG. 10 illustrates detail I from FIG. 1, in an enlarged view.

### DETAILED DESCRIPTION OF SPECIFIC EMBODIMENTS

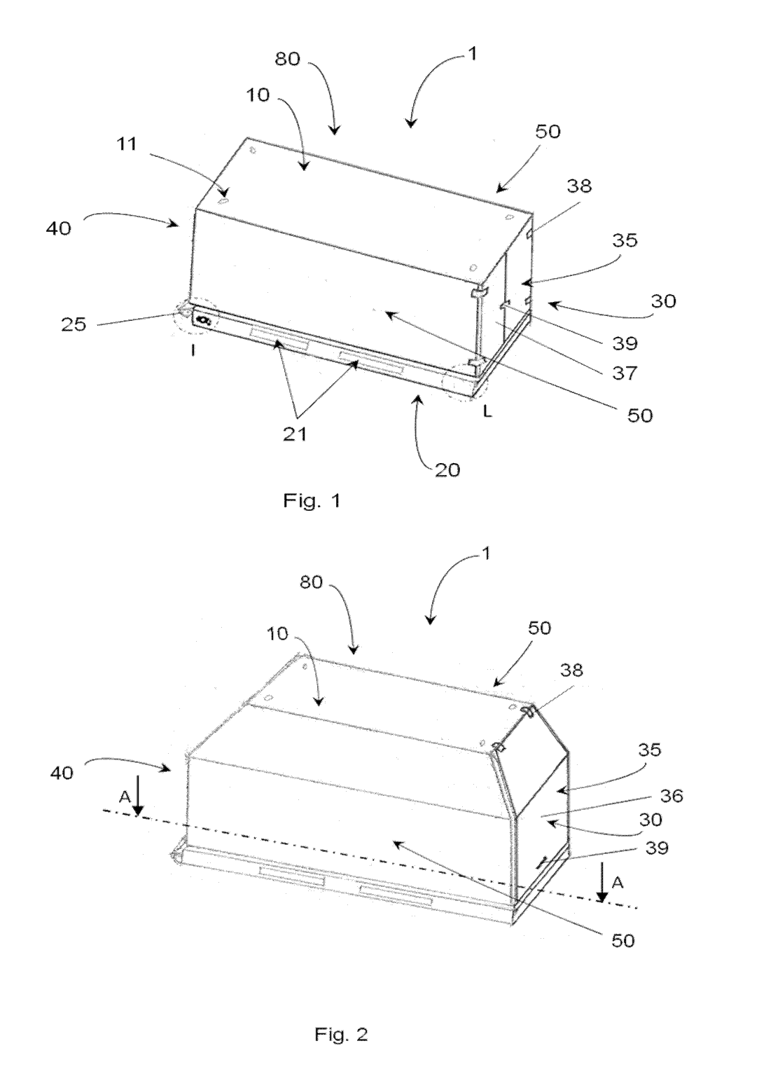

FIG. 1 shows the container (1) according to the subject innovation in a perspective view, with a closed superstructure (80). The closed top (10) of the container can be seen. The top can be clad with sheet metal or with a panel made of a lightweight material such as, for example, an aluminum alloy or plastic. Cladding of the top has the advantage that a vehicle situated in the container (1) is optimally protected against damage due to foreign matter striking it from above such as hailstones or falling objects. In another embodiment, the top (10) is closed by a tarpaulin that is attached between elements of a frame. Another embodiment provides for an open top (10) between elements of the frame. Four crane lugs (11) are attached to the top (10). The lifting mechanism for a forklift or a crane can be attached to these crane lugs and it can then lift the container (1). At two end faces (40) at the bottom (20) of the container (1), there are rollers (25) on which the container (1) can be rolled once it has been lifted at the first end face (30). Moreover, two fork entries (21) in one lengthwise side (50) of the container (1) can be seen. These fork entries are located in the floor element (5) of the container (1). This is where the tines of a forklift can be inserted in order to lift the container. The first end face (30), through which the container (1) can be loaded, has a reclosable opening (35) that is closed with a leaf door (37). The leaves of this leaf door (37) are fastened with hinges (38) to the lengthwise sides (50) of the container (1). The door (37) has a lock (39) with which the door can be locked and which can be configured as a security seal for customs purposes.

FIG. 2 shows a second embodiment of the container (1) in a perspective view with a closed superstructure (80). In this embodiment, the walls of the end faces (30, 40) and the lengthwise sides (50) are angled in the upper area towards the middle of the container. Vehicles usually have a narrower contour in the upper area than in the lower area so that, in spite of these angled walls, most vehicle models can be transported in the container (1). The angling of the container walls in the upper area has the advantage that the container matches the contour of the freight holds of airplanes, as a result of which more containers (1) can be transported in one airplane. The first end face (30), through which the container (1) can be loaded, has a reclosable opening (35) that is closed with a hatch (36). The hatch (36) is fastened with hinges (38) to the top (10) of the superstructure (80). The shape of the closure (36, 37) of the reclosable opening (35) of the container (1) does not depend on the contour of the container walls, so that appropriate embodiments can be combined with each other as desired. The hatch also has a lock (39) with which it can be locked. This lock can be configured as a security seal for customs purposes.

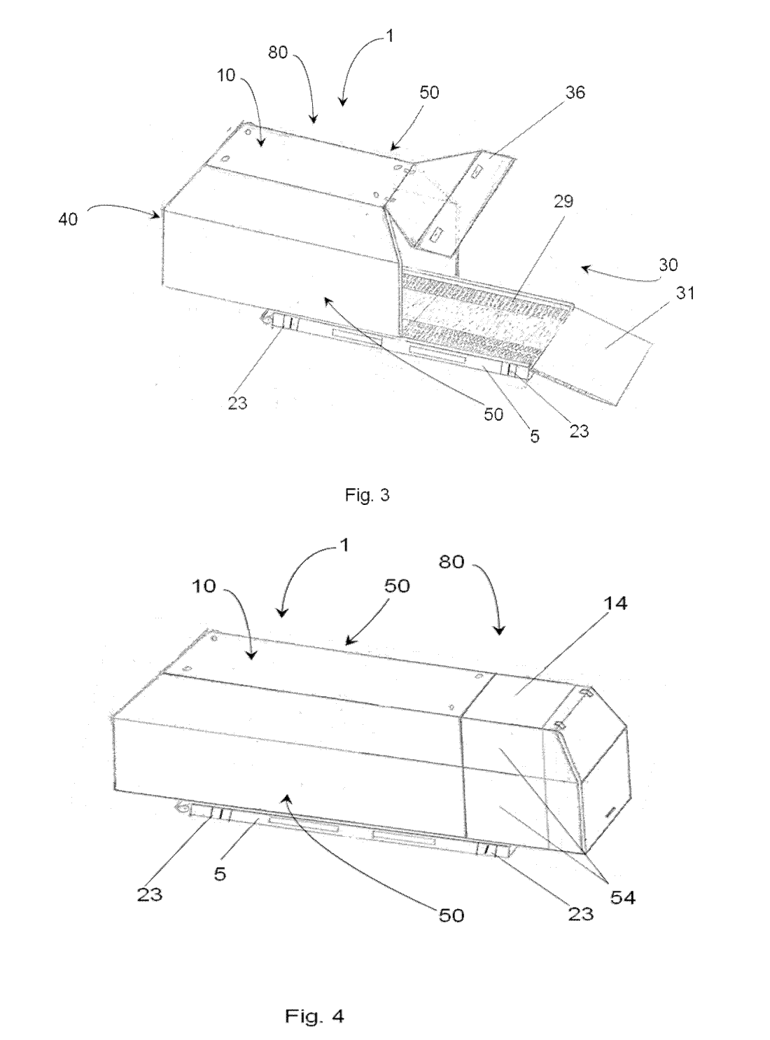

FIG. 3 shows the container (1) with an open superstructure (80), in a perspective view. The floor element (5) of the container (1) has a drive-on ramp (29) made of perforated sheet metal. The shape and spacing of the holes are selected here in such a way that it is easy to attach appropriate securing mechanisms to them. On the first end face (30), a ramp (31) is pivotably joined to the floor element (5). In FIG. 2, the ramp (31) is folded open onto the ground in front of the container (1) so that a vehicle can be driven onto the drive-on element (29) of the floor element (5). The operating personnel can open the vehicle doors all the way so that they can easily get in and out of the vehicle without damaging the car doors. The lengthwise sides of the floor element (5) have lugs (23) with which the container (1) can be securely tied down in a given vehicle of transportation such as an airplane, a ship, a sea container or a truck.

FIG. 4 shows the container with an extended superstructure (80), in the closed position and in a perspective view. In order to extend the superstructure, the lengthwise sides (50) and the top (10) are each configured in two parts. The parts can be separated in order to insert intermediate pieces (14, 54). The superstructure (80) can thus be lengthened while the floor element (5) remains the same size, so that vehicles with an extra long axial chassis can be transported. In order to be able to load such vehicles without running the risk that the extra long chassis will hit the ground, the ramp (31) can be lengthened by suitable additional elements. In an advantageous embodiment, these additional elements can be stowed in the roof of the superstructure (80) for transport (not shown here). Moreover, if vehicles with a very low chassis clearance are to be loaded, it is advantageous to use such ramps that are longer than the ramp (31) that is attached to the floor element (5).

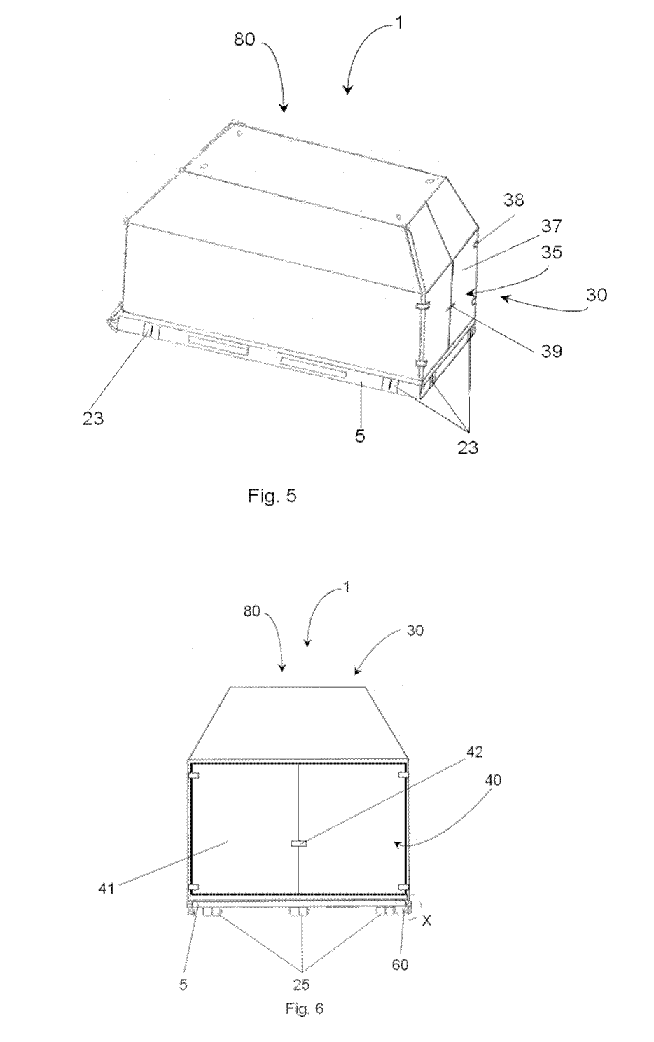

FIG. 5 shows the container (1) in a perspective view with a closed superstructure (80). In the embodiment shown in FIG. 5, the first end face (30), through which the container (1) can be loaded and which has the reclosable opening (35), is closed with a two-leaf door (37). The door leaves are fastened with hinges (38) to the lengthwise sides (50) of the container (1). The door (37) likewise has a lock (39) with which the door can be locked. This lock can be configured as a security seal for customs purposes.

The embodiment of the container (1) shown in FIG. 5 has a floor element (5) in which lugs (23) are provided not only in the lengthwise sides (50) but also in the end faces (30, 40). Here, the arrangement of the lugs (23) does not depend on the embodiment of the container (1) with a hatch (36) or leaf door (37). The leaf door (37) can also be configured as a single-leaf door. Here, too, the closure of the reclosable opening (35) of the container (1) is conceivable using other suitable closure elements such as, for example, an accordion door or a roller shutter.

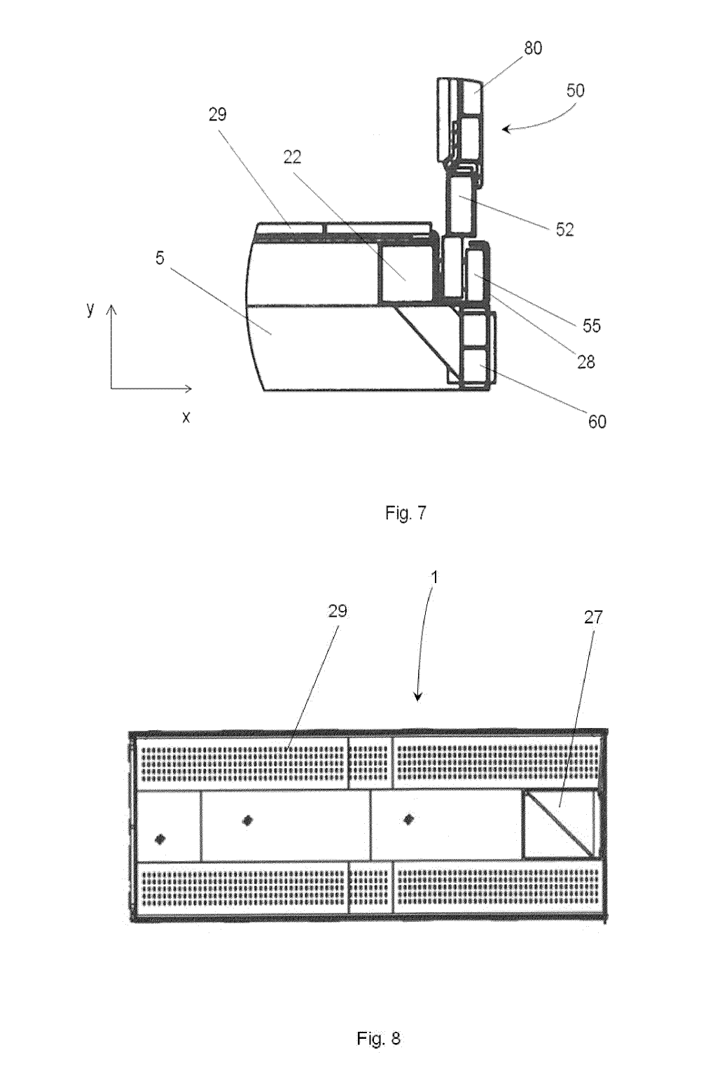

FIG. 6 is a view of the second end face (40) of the container (1). The container (1) can be moved on three double rollers (25) that, at the second end face (40), are attached to the floor element (5) once the container (1) has been lifted at the first end face (30). The superstructure (80) can be moved on guide rollers (55) (FIG. 7) and support rollers (60) relative to the floor element (5). At the second end face (40), the container (1) can also have an additional access modality (41) that can be closed by a suitable closure element such as, for example, a door or a hatch. This facilitates the access to the front or rear of a loaded vehicle that is facing in the direction of this second end face (40). This additional access modality (41) can also have a lock (42) so that the container can also be configured so that it can be locked, even if it has the additional access modality (41).

FIG. 7 is the detail X from FIG. 6. The frame (22) of the floor element (5) has a profile (28) in the lengthwise direction in which a guide roller (55) that is attached to the side part (50) can run. This profile (28) is shaped in such a way that the guide roller (55) encounters a resting surface in the negative y-direction, and runs laterally in the x-direction and upwards in the y-direction. The guide roller is connected to the superstructure (80) via a frame (52) of the lengthwise sides (50). Moreover, the superstructure (80) is supported relative to the ground on a support roller (60).

FIG. 8 is the section A-A from FIG. 2 through the container (1). The bottom (20) of the container (1) is configured towards the inside of the container (1) with drive-on elements (29). These drive-on elements (29) consist of perforated plates to which securing mechanisms for the vehicle can easily be secured. Between the drive-on elements (29), the bottom (20) has a tray (27) in which, for example, the securing mechanisms for vehicles can be transported when they are not being used. This tray (27) can be closed by a closure element (not shown here). The bottom (20) can be open between the drive-on elements. However, it is also possible to clad the bottom in addition to the drive-on elements or only between the drive-on elements, or else to close them in some other manner, for instance, with a tarpaulin.

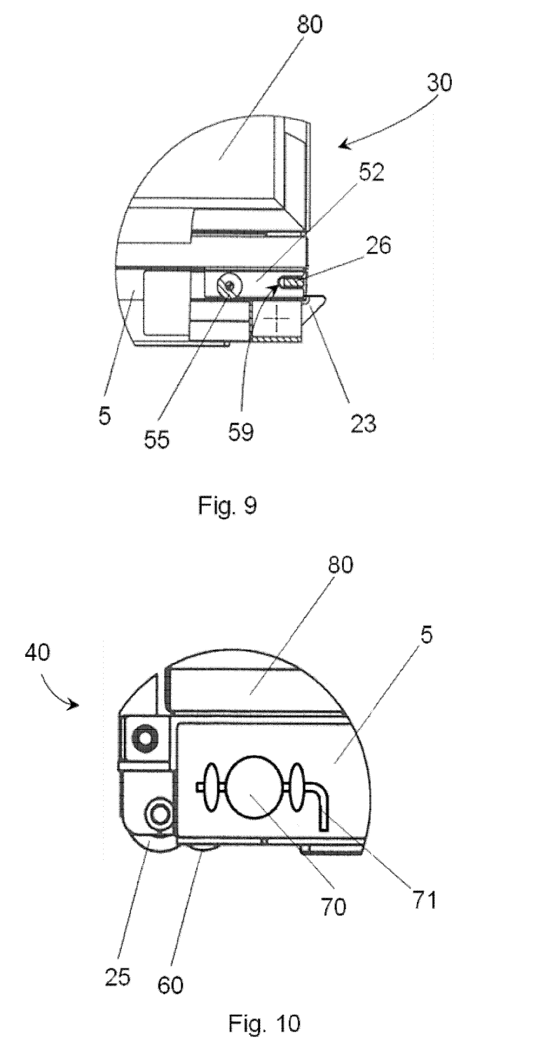

FIG. 9 shows the detail L from FIG. 1. In the frame (52) of the lengthwise side, there is a recess (59) that accommodates a pin (26) that is located on the floor element (5) of the container (1) when the superstructure (80) is closed, and it secures the superstructure (80) against lifting off when in the closed state. The end faces (30, 40) also have lugs (23) for securing the container (1) in a vehicle of transportation such as an airplane, a ship, a sea container or a truck.

FIG. 10 is the detail I from FIG. 1. The superstructure (80) is locked in place relative to the floor element (5) by a securing bolt (70). A bar (71) secures the securing bolt (70) against becoming unintentionally loosened.

1-17. (canceled)

18. A container for transporting a vehicle, said container being essentially cuboidal, comprising:
a first end face;
second end face;
two lengthwise sides;
a bottom comprising a floor element;
a top; and
a superstructure that is movable relative to the floor element and that comprises the second end face, the two lengthwise sides, and the top.

19. The container according to claim 18, wherein at the second end face, namely, the end face that faces away from the first end face, the superstructure comprises:
support rollers that extend to the lower edge of the bottom of the container; and
guide rollers disposed at both lengthwise sides that can roll on the floor element of the container, so that the superstructure can be moved relative to the floor element on these support rollers and guide rollers.

20. The container according to claim 19, wherein the superstructure is latched onto the floor element by a latching element in such a way that it cannot be lifted off the floor element.

21. The container according to claim 18, wherein when the superstructure is in the closed state, it can be locked in place relative to the floor element by a pin that extends into a recess.

22. The container according to claim 18, wherein at the first end face, there is a ramp that is pivotably connected to the floor element of the container and, on the one hand, this ramp can be pivoted into the container in such a way that it can be locked in place essentially vertical to the bottom and, on the other hand, it can be pivoted outwards in such a way that it can serve as a drive-on ramp for the floor element.

23. The container according to claim 18, wherein on the first end face of the container, there is a reclosable opening that can be closed with a closure element.

24. The container according to claim 23, comprising a hatch, wherein the reclosable opening can be closed with the hatch that can swing upwards and that serves as the closure element.

25. The container according to claim 23, comprising a leaf door, wherein the reclosable opening can be closed with the leaf door that serves as the closure element.

26. The container according to claim 23, comprising a ramp, wherein the reclosable opening can be closed with the ramp that serves as the closure element.

27. The container according claim 22, comprising security seals, wherein the security seals for customs purposes are provided on the closure element of the reclosable opening.

28. The container according to claim 18, wherein the floor element has a suitable perforated drive-on element on which a vehicle can be driven, so that a vehicle can be locked onto the drive-on element.

29. The container according to claim 18, wherein on the second end face, the floor element comprises a support element on which the container can be moved once it has been lifted at the first end face.

30. The container according to claim 29, wherein the support element is configured so as to rotate around itself.

31. The container according to claim 18, wherein on one lengthwise side, the floor element comprises a fork entry for the load pick-up element of an industrial floor truck.

32. The container according to claim 18, wherein on the top of the container, there are crane lugs such that the container can be lifted.

33. The container according to claim 23, wherein intermediate elements for the top and for the lengthwise sides can be inserted between the top and the lengthwise sides, or can be attached to the top and to the lengthwise sides, so that the superstructure can be extended in the lengthwise direction.

34. The container according to claim 18, wherein the container has elements made of an aluminum alloy.
